(19) United States
(12) Patent Application Publication
(10) Pub. No.: US 2008/0303185 A1
(43) Pub. Date: Dec. 11, 2008

(54) Molding System and Process for Making Product having Reduced Warpage Susceptibility

(75) Inventor: Alireza MORTAZAVI, Richmond Hill (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: HUSKY INJECTION MOLDING SYSTEMS LTD., Bolton (CA)

(21) Appl. No.: 11/760,857

(22) Filed: Jun. 11, 2007

(51) Int. Cl. B29C 43/26

(52) U.S. Cl. 264/238; 264/239; 425/110

(57) ABSTRACT

Disclosed is a molding-system process. The molding-system process includes a receiving operation, including receiving a polymer unit, a cyclic olefin copolymer unit and a reinforcement unit. The polymer unit and the reinforcement unit are separate from each other prior to the polymer unit and the reinforcement unit being received. Once received, the polymer unit, the cyclic olefin copolymer unit and the reinforcement unit are converted into a molding material. The molding material is to be transferred into a mold. In response the mold forms a product having reduced susceptibility to warpage.

### TECHNICAL FIELD

The present invention generally relates to, but is not limited to, molding systems, and more specifically the present invention relates to, but is not limited to, (i) a molding-system process for making a product having reduced susceptibility to warpage, and (ii) a molding-system process for making a product having reduced susceptibility to warpage, and (iii) other arrangements according to the Summary.

### BACKGROUND

Examples of known molding systems are (amongst others): (i) the HyPET™ Molding System, (ii) the Quadloc™Molding System, (iii) the Hylectric™ Molding System, and (iv) the HyMET™ Molding System, all manufactured by Husky Injection Molding Systems (Location: Canada; www.husky.ca).

Parts that are made from a thermoplastic composite, which contains high-aspect ratio reinforcements (such as: glass, carbon, natural or basalt fibers, amongst other equivalent materials), may experience warpage. An example of such a part is a door-module carrier. The high-aspect ratio may be in the range from about 5 to about 1000. Warpage is due to differential shrinkage in a “flow” direction and a “cross-flow” direction induced by fiber orientation in the two directions. However, fiber orientation alone does not necessarily trigger warpage. Local differences in shrinkage and hence internal stresses and warpage occur when orientation (that is, angle of orientation and degree of orientation) changes from point to point. Fibers orient in the flow direction and restrict shrinkage in the flow direction, which is then compensated by an increased shrinkage of the polymer in the transverse direction, which leads to warpage. Factors that influence fiber orientation have an impact on warpage; and such factors include: (i) gate location, (ii) injection-compression molding, (iii) lower fiber concentration, and (iv) resin viscosity, etc.

Options that may be used to reduce warpage include: (i) gating, and/or (ii) flow pattern in injection compression. Gating can be used to minimize fiber orientation; a part with a large number of gates spread evenly over the surface will have short flow lengths, will fill primarily with radial flow patterns, and will pack uniformly; however, part geometry may restrict this option, and cost of additional drops on a hot runner may be prohibitive. Flow pattern in injection compression will: (i) have short flow lengths, (ii) fill primarily with radial flow patterns, and (iii) pack more uniformly than injection; this option helps to reduce warpage; however, this option may require additional post-molding steps (such as: trimming or punching holes) that result in wastage, extra manufacturing steps, and increased part cost.

A common method to reduce warpage is to add a small amount of flake reinforcements such as mica or talc in addition to the fibers. The mica or talc has an aspect ratio that is greater than 1 but less than 20; usually, this does not include a particulate that has aspect ratio of 1, such as calcium carbonate. Usage of flake-type reinforcements, which have a lower aspect ratio than long fibers, result in a degree of shrinkage that tends to be more isotropic (that is, less warpage); however, mechanical properties, such as tensile strength or impact strength, are reduced.

According to a BASF Plastics Brochure (Technical Information for Experts 05/99e; Title: Warpage Characteristics of Fiber-reinforced Injection-molded Parts), there are marked differences in the shrinkage characteristics of un-reinforced and glass-fiber reinforced thermoplastics. The design rules applicable to un-reinforced plastic parts for minimizing warpage have only limited validity for glass-fiber reinforcement. The dominant determining factor in this case is the orientation of the fibers. In order to be in a position to take any possible warpage into consideration as early as the design phase or to optimize the warpage behavior of prototype parts, the causes and mechanisms of fiber orientation together with their effects on shrinkage behavior must be known. This understanding allows the derivation of design rules and measures for the minimization of warpage. The summary of design rules are: (i) aim for a uniform direction of flow (that is, direction of orientation), (ii) gate oblong parts in a longitudinal direction, (iii) aim for and/or emphasize symmetry, (iv) avoid ribs or walls transverse to a direction of flow, (v) position the end of a flow path in corners, (vi) take account of transverse orientation at an end of a flow path and along edges, (vii) aim for flow lines which are as blunt as possible (that is, pay attention to strength), (viii) avoid flow lines on free-standing webs or displace them into corners, and/or (ix) retain the freedom to make changes.

According to pages 29 to 33 of Chapter 4 (Causes of Molded-Part Variation: Material) associated with a publication titled “Handbook of Molded Part Shrinkage and Warpage” (Author: Jerry M. Fisher; ISBN: 2002014824), a common misunderstanding is that the shrinkage values listed on data sheets are a direct indication of potential part warpage. A more reliable indication of warp would be the differential shrinkage obtained by subtracting shrinkage in a flow direction from that in a transverse direction. This is equally valid for semi-crystalline and amorphous resins, but greater attention to differential shrinkage is required with semi-crystalline plastics. Fillers also influence the shrinkage by offsetting some volume of polymer with a low-shrinking filler particle. The shrinkage of resins containing isotropic fillers (such as glass beads or powders) will be more isotropic than resins containing high-aspect-ratio fillers (like fibers or platelets). This results from orientation of the fillers in a flow path during filling, and the restricted shrink along a long axis of the filler particles. Fibers are known to create excessive warp as the restricted shrink in a flow direction is compensated by an increased shrink of the polymer in a transverse direction.

U.S. Pat. No. 6,844,059 (Inventor: Heinz et al.; Published: 2005 Jan. 18) discloses a long-fiber-reinforced polyolefin structure that is also termed “a pellet”. The long-fiber-reinforced polyolefin structure of length being greater than or equal to 3 millimeters (mm) includes: a) from 0.1 to 50% by weight of at least one amorphous cycloolefin polymer, b) from 0.1 to 90% by weight of at least one polyolefin other than a), c) from 5.0 to 75% by weight of at least one reinforcing fiber, and d) up to 10.0% by weight of at least one additive which is different from components a)-c), wherein the percentages are based on the total composition. The moldings of the invention have reduced warpage and increased precision of fit. The object is to provide a long-fiber-reinforced polyolefin structure with very good mechanical properties, good heat resistance, and low water absorption, and also low warpage. The long-fiber-reinforced polyolefin structure is made by a process which includes: I) inducting a fiber bundle through a flat die charged with a melt made from said amorphous cycloolefin polymer a), said polyolefin other than a) (b) and, optionally, from said additive d), II) conducting the immersed fiber bundle through a shaping die, III) cooling the fiber bundle, IV) post forming the fiber bundle, and V) cutting the fiber bundle perpendicular to its running direction to give the length of the structure or winding the fiber bundle up in the form of a continuous structure.

Column 9 lines 44 to 51 (of U.S. Pat. No. 6,844,059) indicates that “a small rod-shaped 45 structure of a certain shape. The length of the rod-shaped structure is from 3 to 100 mm, preferably from 4 to 50 mm, and particularly preferably from 5 to 15 mm. The diameter the rod-shaped structure, also termed a pellet, is from 1 to mm, preferably from 2 to 8 mm, and particularly preferably from 3 to 6 mm”.

Column 9 lines 52 to 56 (of U.S. Pat. No. 6,844,059) indicate that “a process where the components are mixed in an extruder, and the reinforcing fiber is wetted by the melt, and the resultant material is then pelletized. The resultant pellets may be mixed with dye 55 and/or pigment and further processed to give the component”.

Column 9 lines 60 to 64 (of U.S. Pat. No. 6,844,059) indicates that “A shaped article is molded from the molten, where appropriate colored, long-fiber reinforced polyolefin pellets in a manner known per se, such as injection molding, extrusion, blow molding, or compression with plastification”.

Column 11 lines 11 to 20 (of U.S. Pat. No. 6,844,059) indicates that “moldings of this type may also be obtained by mixing long-fiber-reinforced polyolefin structures which are currently commercially available with pellets made from amorphous cycloolefin polymer, and then producing the moldings by the known processes from this mixture of pellets, in such a way that the content of amorphous cycloolefin polymer in the pellet mixture and in the moldings produced therefrom corresponds to the content of amorphous cycloolefin polymer in the polyolefin structures of the invention”.

It appears that according to U.S. Pat. No. 6,844,059, the long-fiber-reinforced polyolefin structure is a pellet having, in combination, a polyolefin, an amorphous cycloolefin polymer and a reinforcing fiber.

### SUMMARY

According to a first aspect of the present invention, there is provided a molding-system process, including: a receiving operation, including receiving a polymer unit, a cyclic olefin copolymer unit and a reinforcement unit, the polymer unit and the reinforcement unit being separate from each other prior to the polymer unit and the reinforcement unit being received, the received polymer unit, cyclic olefin copolymer unit and reinforcement unit are to be converted into a molding material, the molding material to be transferred into a mold, and in response the mold forming a product having reduced susceptibility to warpage.

According to a second aspect of the present invention, there is provided a molding-system process, including: (i) a receiving operation, including receiving a polymer unit, a cyclic olefin copolymer unit and a reinforcement unit, the polymer unit and the reinforcement unit being separate from each other prior to the polymer unit and the reinforcement unit being received, (ii) a converting operation, including converting the polymer unit, the cyclic olefin copolymer unit and the reinforcement unit into a molding material, and (iii) a transferring operation, including transferring the molding material into a mold, and in response the mold forming a product having reduced susceptibility to warpage.

According to a third aspect of the present invention, there is provided a molding system, including: (i) means for receiving a polymer unit, a cyclic olefin copolymer unit, and a reinforcement unit, the polymer unit and the reinforcement unit being separate from each other prior to the polymer unit and the reinforcement unit being received, (ii) means for converting the cyclic olefin copolymer unit, the polymer unit and the reinforcement unit into a molding material, and (iii) means for transferring, including transferring the molding material into a mold, and in response the mold forming a product having reduced susceptibility to warpage.

According to a fourth aspect of the present invention, there is provided a molding system, including: (i) a receiver configured to receive a polymer unit, a cyclic olefin copolymer unit and a reinforcement unit, the polymer unit and the reinforcement unit being separate from each other prior to the polymer unit and the reinforcement unit being received, (ii) a converter coupled to the receiver, the converter configured to receive the cyclic olefin copolymer unit, the polymer unit and the reinforcement unit from the receiver, the converter configured to convert the cyclic olefin copolymer unit, the polymer unit and the reinforcement unit into a molding material, and (iii) a transfer mechanism coupled to the converter, the transfer mechanism configured to transfer the molding material from the converter to a mold, and in response the mold forming a product having reduced susceptibility to warpage.

A technical effect, amongst other technical effects, of the aspects of the present invention is improved quality associated with a molded article.

### DESCRIPTION OF THE DRAWINGS

A better understanding of the non-limiting embodiments of the present invention (including alternatives and/or variations thereof) may be obtained with reference to the detailed description of the non-limiting embodiments along with the following drawings, in which:

FIG. 1 depicts a schematic representation of a molding-system process 10 according to a first non-limiting embodiment and variants thereof;

FIG. 2 depicts a schematic representation of: (i) a molding system 100 that operates according to the molding-system process 10 of FIG. 1 according to a second non-limiting embodiment and variants thereof, (ii) a molded product 99 made by the molding-system process 10 of FIG. 1 according to a third non-limiting embodiment and variants thereof, and (iii) an input 1 of the molding-system process 10 of FIG. 1 according to a fourth non-limiting embodiment and variants thereof;

FIG. 3 depicts a schematic representation of: (i) a molding system 200 that operates in accordance with the molding-system process 10 of FIG. 1 according to a fifth non-limiting embodiment and variants thereof, (ii) a computer program product 262 that is used to a controller 260 used to direct the molding system 200 in accordance with the molding-system process 10 of FIG. 1 according to a sixth non-limiting embodiment and variants thereof, and (iii) the controller 260 used to direct the molding system 200 in accordance with the molding-system process 10 of FIG. 1 according to a seventh non-limiting embodiment and variants thereof; and

FIG. 4 depicts a schematic representation of: (i) a molding system 300 that operates in accordance with the molding-system process 10 of FIG. 1 according to an eighth non-limiting embodiment and variants thereof, (ii) a computer program product 362 that is used to a controller 360 used to direct the molding system 300 in accordance with the molding-system process 10 of FIG. 1 according to a ninth non-limiting embodiment and variants thereof, and (iii) the controller 360 used to direct the molding system 300 in accordance with the molding-system process 10 of FIG. 1 according to a tenth non-limiting embodiment and variants thereof.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### REFERENCE NUMERALS USED IN THE DRAWINGS

The following is a listing of the elements designated to each reference numeral used in the drawings:
input, 1
polymer unit, 2
cyclic olefin copolymer unit, 4
reinforcement unit, 6
additive, 8
molding-system process, 10
receiving operation, 12
converting operation, 14
transferring operation, 16
injection-molding operation, 18
extrusion molding operation, 20
compression molding operation, 22
thermal-forming operation, 24
resin-transfer molding operation, 26
reaction-injection molding operation, 28
mold, 50
stationary mold portion, 52
movable mold portion, 54
molded product, 99
molding systems, 100; 200; 300
means for receiving, 102
means for converting, 104
means for transferring, 106
extruder assemblies, 220; 320
receivers, 221; 321
screw structure, 222
converters, 223; 323
hopper assemblies, 224; 324
feed throats, 225, 325
transfer mechanisms, 241; 341
motors, 226; 326
barrels, 228; 328
hot runners, 230; 330
stationary platens 242; 342
movable platens 244; 344
machine nozzles, 243; 343
controllers, 260; 360
computer program products, 262; 362
clamp assemblies, 280; 380
nuts, 282; 382
rods, 284; 384
clamp units, 286; 386
multiple-screw structure, 322
conduit, 350
manifold, 352
shooting pot, 355
piston, 356

### DETAILED DESCRIPTION OF THE NON-LIMITING EMBODIMENTS

According to U.S. Pat. No. 6,844,059, the long-fiber-reinforced polyolefin structure (hereafter referred to as the “LFRP structure”) is a pellet having, in combination: (i) a polyolefin, (ii) an amorphous cycloolefin polymer, and (iii) a reinforcing fiber. It appears that (based on U.S. Pat. No. 6,844,059) the LFRP structure, which is an input to a molding process, is manufactured before it is used as an input to the molding process; specifically, the LFRP structure is manufactured and then it is purchased for use as an input to a molding system or the molding process. A significant drawback, as identified by the inventor, to the arrangement associated with U.S. Pat. No. 6,844,059 is that it may be costly for a manufacturer of molded parts to purchase these “pre-manufactured” pellets (that is, the LFRP structures) for use as an input to the molding process. In sharp contrast to U.S. Pat. No. 6,844,059, according to the non-limiting embodiments, costs associated with purchasing raw material inputs (that is, the inputs to the molding system) are reduced because the material inputs include: (i) a cyclic olefin copolymer, (ii) a polymer, and (iii) a reinforcement material. The cyclic olefin copolymer may hereafter, from time to time, be referred to as the “COC”. The polymer may also be called a thermoplastic or a thermoset. The reinforcement material includes any one of: glass, carbon, natural or basalt fibers, amongst others equivalent items. It may be advantageous to merely add the cyclic olefin copolymer, the polymer and the reinforcement material to an extruder or a hopper of a molding system so that in this manner, (i) warpage of the molded part is reduced, and (ii) costs associated with obtaining and using the inputs are reduced as much as possible. According to the inventor, the it appears that the subject matter associated with U.S. Pat. No. 6,844,059 teaches away from the non-limiting embodiments.

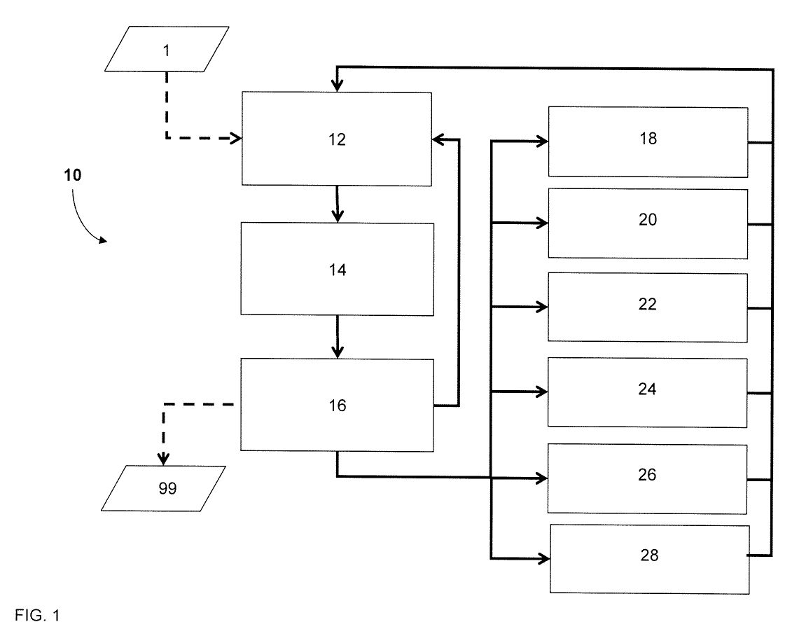

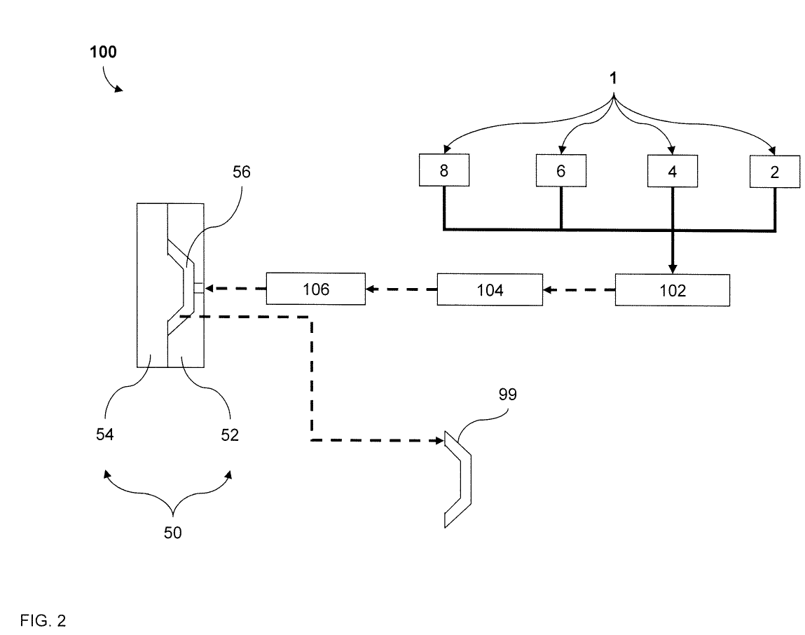

FIG. 1 depicts the molding-system process 10 (hereafter referred to as the “process 10”) according to the first non-limiting embodiment. The process 10 is used to mold a molded product 99. The process 10 includes a receiving operation 12, which includes receiving an input 1. The input 1 includes at least one of: (i) a polymer unit 2, (ii) a cyclic olefin copolymer unit 4, and (iii) a reinforcement unit 6, all of which are depicted in FIGS. 2, 3, and 4. It will be appreciated that several vendors may supply the polymer unit 2, the cyclic olefin copolymer unit 4, and the reinforcement unit 6 in any combination and permutation thereof. According to a non-limiting variant, the polymer unit 2 is separate from the reinforcement unit 6 prior to the polymer unit 2 and the reinforcement unit 6 being received. The process 10 further includes: (i) a converting operation 14, and (ii) a transferring operation 16. The converting operation 14 includes converting the polymer unit 2, the cyclic olefin copolymer unit 4 and the reinforcement unit 6 into a molding material. The transferring operation 16 includes transferring the molding material into a mold 50, which is depicted in FIGS. 2, 3, and 4. In response the mold 50 forms a product (that is, the molded product 99) that has reduced susceptibility to warpage. The process 10 includes any one of: (i) an in-line compounding (ILC) molding process, (ii) an ILC compression molding process, (iii) an ILC-injection molding process, or (iv) an ILC resin-transfer molding process. It is understood that the cyclic olefin copolymer includes equivalents thereof, such as cycloolefin polymer (amorphous or otherwise) and/or equivalents thereof. According to a non-limiting variant, the process 10 further includes any one of the following operations: (i) an injection-molding operation 18, including injection molding of the molding material, (ii) an extrusion molding operation 20, including extrusion molding of the molding material, (iii) a compression molding operation 22, including compression molding of the molding material, (iv) a thermal-forming operation 24, including thermal forming of the molding material, (v) a resin-transfer molding operation 26, including resin transfer mold forming of the molding material, and/or (vi) a reaction-injection molding operation 28, including reaction mold forming of the molding material.

According to non-limiting variants, (i) the reinforcement unit 6 includes a shape having an aspect ratio greater than 1, (ii) the polymer unit 2 includes the cyclic olefin copolymer unit 4 prior to the polymer unit 2 being received by the molding system, (iii) the reinforcement unit 6 includes the cyclic olefin copolymer unit 4 prior to the reinforcement unit 6 being received by the molding system, or (iv) the polymer unit 2, the cyclic olefin copolymer unit 4 and the reinforcement unit 6 are all separate from each other prior to the polymer unit 2, cyclic olefin copolymer unit 4 and the reinforcement unit 6 being received by the molding system.

According to a non-limiting variant: (i) the receiving operation 12 further includes receiving an additive 8, which is depicted in FIGS. 2, 3, and 4, and (ii) the converting operation 14 further includes converting the polymer unit 2, the cyclic olefin copolymer unit 4, the reinforcement unit 6 and the additive 8 into the molding material. According to non-limiting variants, (i) the additive 8 includes the cyclic olefin copolymer unit 4 prior to the additive 8 being received by the molding system, (ii) the polymer unit 2, the cyclic olefin copolymer unit 4, the reinforcement unit 6 and the additive 8 are all separate from each other prior to the polymer unit 2, the cyclic olefin copolymer unit 4, the reinforcement unit 6 and the additive 8 being received by the molding system, and/or (iii) the additive 8 includes any one of a colorant, a stabilizer and/or a lubricant in any combination and permutation thereof.

FIG. 2 depicts the schematic representation of: (i) the molding system 100 (preferably an injection molding system, hereafter referred to as the “system 100”) according to the second non-limiting embodiment, (ii) the molded product 99 (according to the third non-limiting embodiment) made by the system 100 operating in accordance with the process 10 of FIG. 1, and (iii) the input 1 of the process 10 of FIG. 1 according to the fourth non-limiting embodiment. The system 100 includes components that are known to persons skilled in the art and these known components will not be described here; these known components are described, at least in part, in the following text books (by way of example): (i) Injection Molding Handbook by Osswald/Turng/Gramann (ISBN: 3-446-21669-2; publisher: Hanser), (ii) Injection Molding Handbook by Rosato and Rosato (ISBN: 0-412-99381-3; publisher: Chapman & Hill), and/or (iii) Injection Molding Systems 3^{rd} Edition by Johannaber (ISBN 3-446-17733-7). The system 100 includes: (i) means for receiving 102, (ii) means for converting 104, and (iii) means for transferring 106. The means for receiving 102 is configured to: (i) receive the polymer unit 2, (ii) receive the cyclic olefin copolymer unit 4, and (iii) receive the reinforcement unit 6. The polymer unit 2 and the reinforcement unit 6 are separate from each other prior to the system 100 receiving the polymer unit 2 and the reinforcement unit 6. The means for converting 104 is configured to: (i) receive, from the means for receiving 102, the polymer unit 2, the cyclic olefin copolymer unit 4, and the reinforcement unit 6, and (ii) convert the polymer unit 2, the cyclic olefin copolymer unit 4 and the reinforcement unit 6 into a molding material. The means for transferring 106 is configured to transfer the molding material that was made by the means for converting 104 into a mold 50; in response the mold 50 forms a product having reduced susceptibility to warpage. The mold 50 defines a mold cavity 56. The mold 50 includes a stationary mold portion 52 and a movable mold portion 54 that is movable relative to the stationary mold portion 52. The molded product 99 is made in the mold 50 by usage of the system 100.

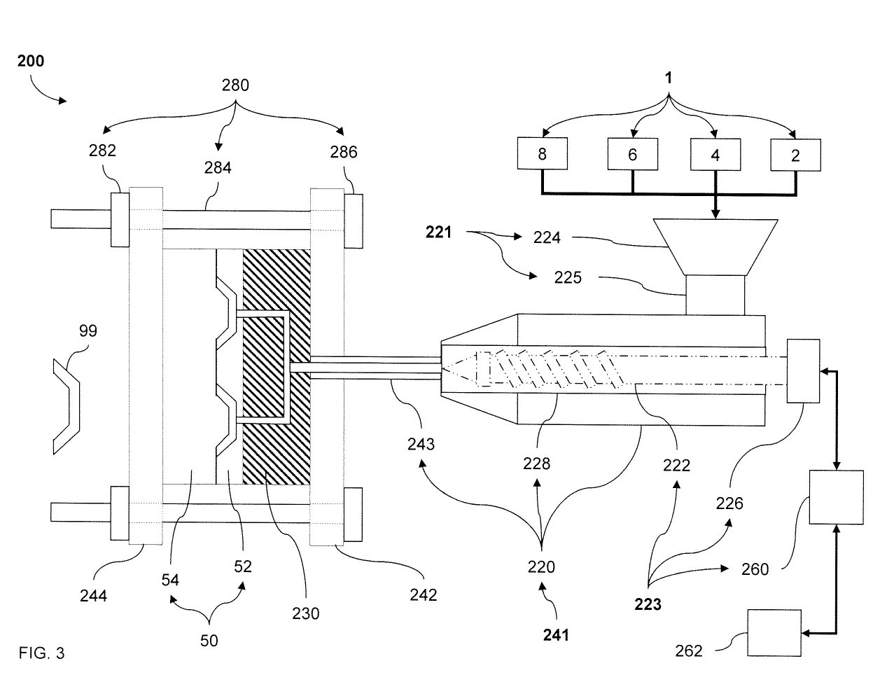

FIG. 3 depicts the schematic representation of: (i) the molding system 200 (preferably an injection-molding system, hereafter referred to as the “system 200”) according to the fifth non-limiting embodiment, (ii) the computer program product 262 according to the sixth non-limiting embodiment, and (iii) the controller 260 according to the seventh non-limiting embodiment. The system 200 is used to mold a molded product 99. The system 200 includes components that are known to persons skilled in the art and these known components will not be described here; these known components are described, at least in part, in the following text books (by way of example): (i) Injection Molding Handbook by Osswald/Turng/Gramann (ISBN: 3-446-21669-2; publisher: Hanser), (ii) Injection Molding Handbook by Rosato and Rosato (ISBN: 0-412-99381-3; publisher: Chapman & Hill), and/or (iii) Injection Molding Systems 3^{rd} Edition by Johannaber (ISBN 3-446-17733-7). The system 200 includes (amongst other things): (i) a receiver 221, (ii) a converter 223, and (iii) a transfer mechanism 241. The receiver 221 is configured to receive the polymer unit 2, the cyclic olefin copolymer unit 4 and the reinforcement unit 6. The polymer unit 2 and the reinforcement unit 6 are separate from each other prior to the system 200 receiving the polymer unit 2 and the reinforcement unit 6. The converter 223 is coupled to the receiver 221; the converter 223 is configured to: (i) receive the polymer unit 2, the cyclic olefin copolymer unit 4 and the reinforcement unit 6 from the receiver 221, and (ii) convert the polymer unit 2, the cyclic olefin copolymer unit 4 and the reinforcement unit 6 into a molding material. The transfer mechanism 241 is coupled to the converter 223. The transfer mechanism 241 is configured to transfer the molding material from the converter 223 to the mold 50; in response the mold 50 forms a molded product 99 (or molded article) that has reduced susceptibility to warpage.

According to a non-limiting variation, the receiver 221 is further configured to receive the additive 8, and the converter 223 is further configured to convert the polymer unit 2, the cyclic olefin copolymer unit 4, the reinforcement unit 6 and the additive 8 into the molding material.

The receiver 221 includes: (i) a hopper assembly 224, and (ii) a feed throat 225. The hopper assembly 224 is configured to receive the polymer unit 2, the cyclic olefin copolymer unit 4 and the reinforcement unit 6. The feed throat 225 is coupled to the hopper assembly 224.

The converter 223 includes: (i) a screw structure 222; (ii) a motor 226, and (iii) a controller 260. The motor 226 is coupled to the screw structure 222. The motor 226 is configured to drive the screw structure 222 (for example, to rotate and/or translate the screw structure 222). The screw structure 222 is configured to convert the polymer unit 2, the cyclic olefin copolymer unit 4 and the reinforcement unit 6 into the molding material (by using friction). The controller 260 includes a computer program product 262. The computer program product 262 is used for carrying a computer program embodied in a computer-readable medium. The readable medium is adapted (that is, the readable medium includes instructions) to direct (that is, instruct) the controller 260 so that the controller 260 controls the motor 226, so that, in turn, the motor 226 may actuate the screw structure 222 so as to perform the process 10 of FIG. 1

The transfer mechanism 241 includes an extruder assembly 220. The extruder assembly 220 includes: (i) a barrel 228, and (ii) a machine nozzle 243. The barrel 228 is connected with the feed throat 225. The barrel 228 is configured to receive the screw structure 222. The machine nozzle 243 is connected with an output of the barrel 228. The machine nozzle 243 is configured to convey the molding material away from the barrel 228 toward the mold 50.

According to a non-limiting variant, the system 200 further includes: (i) a stationary platen 242, (ii) a movable platen 244, and (iii) a clamp assembly 280. The stationary platen 242 is configured to support a stationary mold portion 52 of the mold 50. The movable platen 244 is configured to support a movable mold portion 54 of the mold 50. The movable platen 244 is movable relative to the stationary platen 242 so as to close the stationary mold portion 52 against the movable mold portion 54. Once the mold portions 52, 54 are closed, a mold cavity is defined that is used to receive the molding material. The clamp assembly 280 is configured to apply a clamping force to the stationary platen 242 and to the movable platen 244 so that the stationary mold portion 52 remains closed against the movable mold portion 54 as the mold 50 receives the molding material under pressure. The clamp assembly 280 includes: (i) rods 284 extending between respective corners of the platens 242, 244, (ii) nuts 282 for securing respective rods 284 to respective corners of the movable platen 244, and (iii) clamp units 286 coupled to respective rods 284 at respective corners of the stationary platen 242. The clamp units 286 are connected to ends of respective rods 284 opposite to respective nuts 282. The clamp unit 286 is configured to apply a clamping force to the rod 284, so that in this manner the clamping force may be applied or transmitted to the platens 242, 244. According to a non-limiting variant, the mold 50 includes a plurality of mold cavities, and a hot runner 230 that is configured to connect the machine nozzle 243 so as to fill the plurality of mold cavities with the molding material. Since the mold 50 wears out and is replaced with a new or refurbished mold, the system 200 and the mold 50 may be supplied by different vendors. In addition, since the mold 50 and the hot runner 230 are matched together (for performance reasons), once vendor may supply the hot runner 230 while another vendor supplies the system 200.

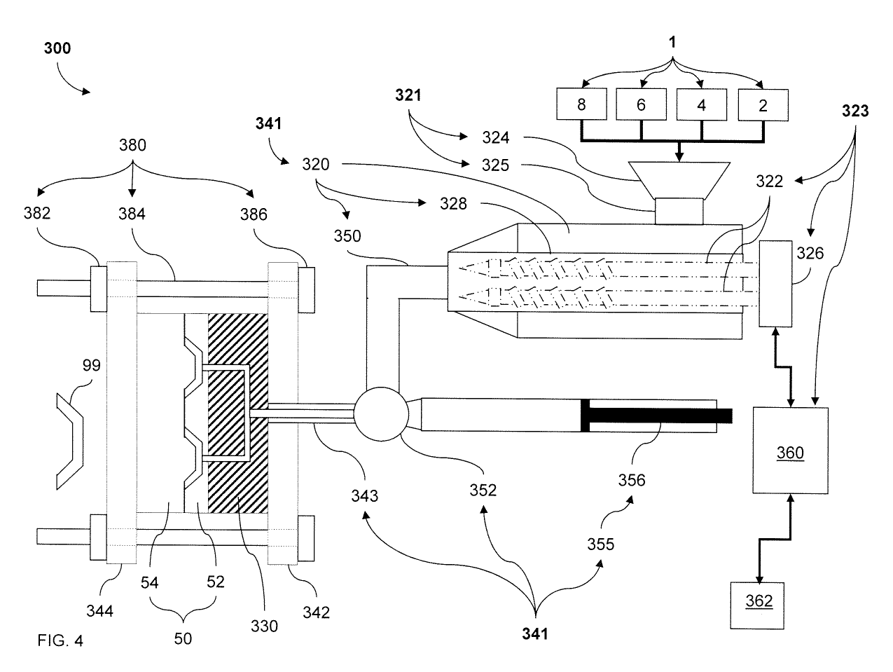

FIG. 4 depicts the schematic representation of: (i) the molding system 300 (preferably an injection-molding system, hereafter referred to as the “system 300”) according to the eighth non-limiting embodiment, (ii) the computer program product 362 according to the ninth non-limiting embodiment, and (iii) the controller 360 according to the tenth non-limiting embodiment. The system 300 includes components that are known to persons skilled in the art and these known components will not be described here; these known components are described, at least in part, in the following text books (by way of example): (i) Injection Molding Handbook by Osswald/Turng/Gramann (ISBN: 3-446-21669-2; publisher: Hanser), (ii) Injection Molding Handbook by Rosato and Rosato (ISBN: 0-412-99381-3; publisher: Chapman & Hill), and/or (iii) Injection Molding Systems 3^{rd} Edition by Johannaber (ISBN 3-446-17733-7). To facilitate an understanding of the non-limiting embodiments depicted in FIG. 4, elements of these non-limiting embodiments are identified by reference numerals that use a three-hundred designation rather than a two-hundred designation (as used in the non-limiting embodiments associated with FIG. 3). The system 300 may be operable in any one of a discontinuous process (which is depicted in FIG. 4) and a continuous process (which is not depicted). The molding system 300 as depicted in FIG. 4 is operated in discontinuous process.

The receiver 321 includes: (i) a hopper assembly 324 and (ii) a feed throat 325. The hopper assembly 324 is configured to receive the polymer unit 2, the cyclic olefin copolymer unit 4 and the reinforcement unit 6. The feed throat 325 is coupled with the hopper assembly 324. The hopper assembly 324 may include three separate hoppers each of which separately receives an input or a single hopper used to receive all the inputs (the same may be said for the hopper assembly 224 of FIG. 3).

The converter 323 includes: (i) a multiple-screw structure 322 (such as a double screw), (ii) a motor 326, and (iii) a controller 360. The multiple-screw structure 322 is configured to convert the polymer unit 2, the cyclic olefin copolymer unit 4 and the reinforcement unit 6 into the molding material. The motor 326 is coupled to the multiple-screw structure 322. The motor 326 is configured to drive the multiple-screw structure 322. The controller 360 includes a computer program product 362 for carrying a computer program. The computer program is embodied in a computer-readable medium that is adapted to direct the controller 360 to control the motor 326, so that the motor 326 may actuate the multiple-screw structure 322 so as to perform the process 10 of FIG. 1.

The transfer mechanism 341 has or includes an extruder assembly 320. The extruder assembly 320, includes: (i) a barrel 328, (ii) a conduit 350, (iii) a manifold 352, (iv) a machine nozzle 343, and (v) a shooting pot 355. The barrel 328 is coupled with the feed throat 325. The barrel 328 is configured to receive the multiple-screw structure 322. The conduit 350 is connected with an output of the barrel 328. The conduit 350 is configured to convey the molding material away from the barrel 328 and toward the mold 50. The manifold 352 is connected with the conduit 350. The manifold 352 is configured to receive the molding material from the conduit 350. The machine nozzle 343 is connected with the manifold 352. The shooting pot 355 is connected with the manifold 352. The manifold 352 is further configured to: (i) convey, when switched to do so, the molding material to the shooting pot 355 while not conveying the molding material to the machine nozzle 343, and (ii) convey, when switched to do so, the molding material from the shooting pot 355 to the machine nozzle 343 while not conveying the molding material to the conduit 350. The shooting pot 355 includes a piston 356 that is receivable in the shooting pot 355. The piston 356 is configured to shoot the molding material toward the mold 50 via the manifold 352 and the machine nozzle 343. According to a non-limiting variant, the mold 50 includes a plurality of mold cavities, and a hot runner 330 that is configured to connect the machine nozzle 343 so as to fill the plurality of mold cavities with the molding material.

In summary: the discontinuous process includes having the multiple-screw structure 322 of the extruder assembly 320: (i) rotate to make molding material, but (ii) stop rotating while the manifold 352 shuts off so that the shooting pot 355 may translate to inject the molding material into a mold (while avoiding back flow of molding material back into the extruder assembly 320).

According to a variant, the continuous process (not depicted) includes: continuously operating the multiple-screw structure 322 of the extruder assembly 320, and using a buffer (not depicted) between the extruder assembly 320 and the shooting pot 355; in operation: (i) while the extruder assembly 320 fills the buffer with molding material, the shooting pot 355 shoots a shot into a mold, and (ii) while the buffer empties itself into the shooting pot 355, the extruder assembly 320 continues to make more molding material and buffering the molding material in the extruder assembly 320 on a temporary basis. There are patents and technical articles that disclose how to perform the continuous process by using two shooting pots that are alternately filled and emptied wherein the manifold directs the melt flow accordingly.

It will be appreciated that any one of the computer program products 262, 362 (of FIGS. 3 and 4 respectively) and the controllers 260, 360 (of FIGS. 3 and 4 respectively) can be used to adapt (retrofit) an existing molding system (not depicted) to perform the process 10 of FIG. 1.

According to a non-limiting variant, the system 300 further includes: (i) a stationary platen 342, (ii) a movable platen 344, and (iii) a clamp assembly 380. The stationary platen 342 is configured to support a stationary mold portion 52 of the mold 50. The movable platen 344 is configured to support a movable mold portion 54 of the mold 50. The movable platen 344 is movable relative to the stationary platen 342 so as to close the stationary mold portion 52 against the movable mold portion 54. Once the mold portions 52, 54 are closed, a mold cavity is defined that is used to receive the molding material. The clamp assembly 380 is configured to apply a clamping force to the stationary platen 342 and to the movable platen 344 so that the stationary mold portion 52 remains closed against the movable mold portion 54 as the mold 50 receives the molding material under pressure. The clamp assembly 380 includes: (i) rods 384 extending between respective corners of the platens 342, 344, (ii) nuts 382 for securing respective rods 384 to respective corners of the movable platen 344, and (iii) clamp units 386 coupled to respective rods 384 at respective corners of the stationary platen 342. The clamp units 386 are connected to ends of respective rods 384 opposite to respective nuts 382. The clamp unit 386 is configured to apply a clamping force to the rod 384, so that in this manner the clamping force may be applied or transmitted to the platens 342, 344. According to a non-limiting variant, the mold 50 includes a plurality of mold cavities, and a hot runner 330 that is configured to connect the machine nozzle 343 so as to fill the plurality of mold cavities with the molding material. Since the mold 50 wears out and is replaced with a new or refurbished mold, the system 300 and the mold 50 may be supplied by different vendors. In addition, since the mold 50 and the hot runner 330 are matched together (for performance reasons), once vendor may supply the hot runner 330 while another vendor supplies the system 300.

The description of the non-limiting embodiments provides non-limiting examples of the present invention; these non-limiting examples do not limit the scope of the claims of the present invention. The non-limiting embodiments described are within the scope of the claims of the present invention. The non-limiting embodiments described above may be: (i) adapted, modified and/or enhanced, as may be expected by persons skilled in the art, for specific conditions and/or functions, without departing from the scope of the claims herein, and/or (ii) further extended to a variety of other applications without departing from the scope of the claims herein. It is to be understood that the non-limiting embodiments illustrate the aspects of the present invention. Reference herein to details and description of the non-limiting embodiments is not intended to limit the scope of the claims of the present invention. Other non-limiting embodiments, which may not have been described above, may be within the scope of the appended claims. It is understood that: (i) the scope of the present invention is limited by the claims, (ii) the claims themselves recite those features regarded as essential to the present invention, and (ii) preferable embodiments of the present invention are the subject of dependent claims. Therefore, what is to be protected by way of letters patent are limited only by the scope of the following claims:

What is claimed is:

1. A molding-system process, comprising:
a receiving operation, including receiving a polymer unit, a cyclic olefin copolymer unit and a reinforcement unit,
wherein:
once received, the polymer unit, the cyclic olefin copolymer unit and the reinforcement unit are converted into a molding material, and the molding material is to be transferred into a mold, and in response the mold forms a product having reduced susceptibility to warpage, and
the polymer unit and the reinforcement unit are separate from each other prior to the polymer unit and the reinforcement unit being received.

2. A molding-system process, comprising:
a receiving operation, including receiving a polymer unit, a cyclic olefin copolymer unit and a reinforcement unit, the polymer unit and the reinforcement unit being separate from each other prior to the polymer unit and the reinforcement unit being received;
a converting operation, including converting the polymer unit, the cyclic olefin copolymer unit and the reinforcement unit into a molding material; and
a transferring operation, including transferring the molding material into a mold, and in response the mold forming a product having reduced susceptibility to warpage.

3. The molding-system process of claim 2, further comprising any one of:
an injection-molding operation, including injection molding of the molding material;
an extrusion molding operation, including extrusion molding of the molding material;
a compression molding operation, including compression molding of the molding material;
a thermal-forming operation, including thermal forming of the molding material;
a resin-transfer molding operation, including resin transfer mold forming of the molding material; and
a reaction-injection molding operation, including reaction mold forming of the molding material.

4. The molding-system process of claim 2, wherein the reinforcement unit includes a shape having an aspect ratio greater than 1.

5. The molding-system process of claim 2, wherein the polymer unit includes the cyclic olefin copolymer unit prior to the polymer unit being received.

6. The molding-system process claim 2, wherein the reinforcement unit includes the cyclic olefin copolymer unit prior to the reinforcement unit being received.

7. The molding-system process claim 2, wherein the polymer unit, the cyclic olefin copolymer unit, and the reinforcement unit are all separate from each other prior to the polymer unit, the cyclic olefin copolymer unit and the reinforcement unit being received.

8. The molding-system process claim 2, wherein:
the receiving operation further includes receiving an additive; and
the converting operation further includes converting the polymer unit, the cyclic olefin copolymer unit, the reinforcement unit, and the additive into the molding material.

9. The molding-system process of claim 8, wherein the additive includes the cyclic olefin copolymer unit prior to the additive being received.

10. The molding-system process of claim 8, wherein the polymer unit, the cyclic olefin copolymer unit, the reinforcement unit, and the additive are all separate from each other prior to the polymer unit, the cyclic olefin copolymer unit, the reinforcement unit, and the additive being received.

11. The molding-system process of claim 8, wherein the additive includes any one of a colorant, a stabilizer and a lubricant, in any combination and permutation thereof.

12. A computer program product for carrying a computer program embodied in a computer-readable medium adapted to instruct a controller to direct a system to perform the molding-system process of claim 2.

13. A controller including a computer program product for carrying a computer program embodied in a computer-readable medium adapted to direct a system to perform the molding-system process of claim 2.

14. A molded product made from the molding-system process of claim 2.

15. A molding system operable according to the molding-system process of claim 2.

16. An input of the molding-system process of claim 2.

17. An input of the molding-system process of claim 2, the material input being any one of:
(i) the polymer unit,
(ii) the cyclic olefin copolymer unit,
(iii) the reinforcement unit,
(iv) an additive, and
(v) any combination and permutation thereof.

18. A molding system, comprising:
means for receiving a polymer unit, a cyclic olefin copolymer unit, and a reinforcement unit, the polymer unit and the reinforcement unit being separate from each other prior to the polymer unit and the reinforcement unit being received;
means for converting the polymer unit, the cyclic olefin copolymer unit and the reinforcement unit into a molding material; and
means for transferring, including transferring the molding material into a mold, and in response the mold forming a product having reduced susceptibility to warpage.

19. A molding system, comprising:
a receiver configured to receive a polymer unit, a cyclic olefin copolymer unit and a reinforcement unit, the polymer unit and the reinforcement unit being separate from each other prior to the polymer unit and the reinforcement unit being received;
a converter coupled to the receiver, the converter configured to receive the polymer unit, the cyclic olefin copolymer unit and the reinforcement unit from the receiver, the converter configured to convert the polymer unit, the cyclic olefin copolymer unit and the reinforcement unit into a molding material; and
a transfer mechanism coupled to the converter, the transfer mechanism configured to transfer the molding material from the converter to a mold, and in response the mold forming a product having reduced susceptibility to warpage.

20. The molding system of claim 19, wherein:
the receiver is further configured to receive an additive; and
the converter is further configured to convert the polymer unit, the cyclic olefin copolymer unit, the reinforcement unit and the additive into the molding material.

21. The molding system of claim 19, wherein the receiver includes:
a hopper assembly configured to receive the polymer unit, the cyclic olefin copolymer unit and the reinforcement unit, the polymer unit and the reinforcement unit being separate from each other prior to the polymer unit and the reinforcement unit being received; and
a feed throat coupled to the hopper assembly.

22. The molding system of claim 21, wherein the converter includes:
a screw structure;
a motor coupled to the screw structure, the motor configured to drive the screw structure, the screw structure configured to convert the polymer unit, the cyclic olefin copolymer unit and the reinforcement unit into the molding material; and
a controller including:
a computer program product for carrying a computer program embodied in a computer-readable medium adapted to direct the controller to control the motor so that the motor may actuate the screw structure so as to perform a molding-system process.

23. The molding system of claim 22, wherein the transfer mechanism includes:
an extruder assembly, including:
a barrel connected with the feed throat, the barrel configured to receive the screw structure; and
a machine nozzle connected with an output of the barrel, the machine nozzle configured to convey the molding material away from the barrel toward the mold.

24. The molding system of claim 23, further comprising:
a stationary platen configured to support a stationary mold portion of the mold;
a movable platen configured to support a movable mold portion of the mold, the movable platen being movable relative to the stationary platen so as to close the stationary mold portion against the movable mold portion; and
a clamp assembly configured to apply a clamping force to the stationary platen and the movable platen so that the stationary mold portion remains closed against the movable mold portion as the mold receives the molding material.

25. The molding system of claim 19, wherein the converter is operable in any one of a discontinuous process and a continuous process.

26. The molding system of claim 19, wherein the receiver includes:
a hopper assembly configured to receive the polymer unit, the cyclic olefin copolymer unit and the reinforcement unit, the polymer unit and the reinforcement unit being separate from each other prior to the polymer unit and the reinforcement unit being received; and
a feed throat coupled with the hopper assembly.

27. The molding system of claim 26, wherein the converter includes:
a multiple-screw structure;
a motor coupled to the multiple-screw structure, the motor configured to drive the multiple-screw structure, the multiple-screw structure configured to convert the polymer unit, the cyclic olefin copolymer unit and the reinforcement unit into the molding material; and
a controller, including:
a computer program product for carrying a computer program embodied in a computer-readable medium adapted to direct the controller to control the motor so that the motor may actuate the multiple-screw structure so as to perform a molding-system process.

28. The molding system of claim 27, wherein the transfer mechanism includes:
an extruder assembly, including:
a barrel coupled with the feed throat, the barrel configured to receive the multiple-screw structure;
a conduit connected with an output of the barrel, the conduit configured to convey the molding material away from the barrel.

29. The molding system of claim 28, wherein the transfer mechanism includes:
a manifold connected with the conduit, the manifold configured to receive the molding material from the conduit; and
a machine nozzle connected with the manifold.

30. The molding system of claim 29, wherein the transfer mechanism includes:
a shooting pot connected with the manifold, the manifold further configured to: (i) convey the molding material to the shooting pot while not conveying the molding material to the machine nozzle when switched to do so, and (ii) convey the molding material from the shooting pot to the machine nozzle while not conveying the molding material to the conduit when switched to do so.

31. The molding system of claim 30, wherein the shooting pot including:
a piston receivable in the shooting pot, the piston configured to shoot the molding material toward the mold via the manifold and the machine nozzle.

32. The molding system of claim 31, further comprising:
a stationary platen configured to support a stationary mold portion of the mold;
a movable platen configured to support a movable mold portion of the mold, the movable platen being movable relative to the stationary platen so as to close the stationary mold portion against the movable mold portion; and
a clamp assembly configured to apply a clamping force to the stationary platen and the movable platen so that the stationary mold portion remains closed against the movable mold portion as the mold receives the molding material.
